(19) United States
(12) Patent Application Publication
(10) Pub. No.: US 2003/0058128 A1
(43) Pub. Date: Mar. 27, 2003

(54) Wireless information meter

(76) Inventor: Paul D. Crunk, Woodcrest, MI (US)

Correspondence Address: Paul Crunk, 12220 Woodcrest, Box 725, Taylor, MI, 48180, US

(21) Appl. No.: 09/966,675

(22) Filed: Sep. 27, 2001

(51) Int. Cl. G08C 15/06

(52) U.S. Cl. 340/870.02; 340/870.28

(57) ABSTRACT

The Wireless Information Meter is a meter that has solved the many problems of having to use wires to send and receive information from and to meter. Now that the meters can be wireless where they can save in additional cost and installation and also solve the many problems that come along with having to use wires in hooking up to operate and receive and send information. What is very unique about this invention is that the meter can be placed a great distance from the source the information is be received or sent to making the meter more versatile then any wired meters. This meter can perform many functions in one meter without the use of any wires to power it, get information or receive information and can display the information in the meter display with and without the use of control button on the meter and is totally waterproof for indoor or outdoor applications.

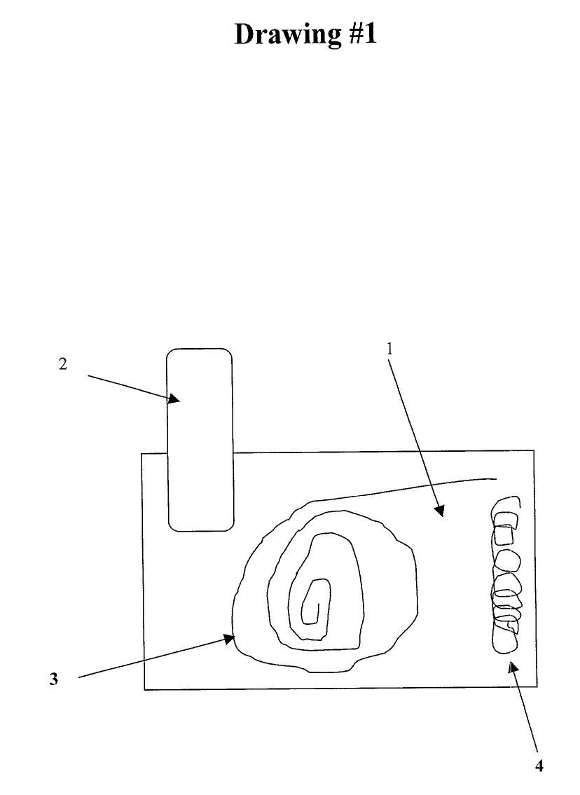

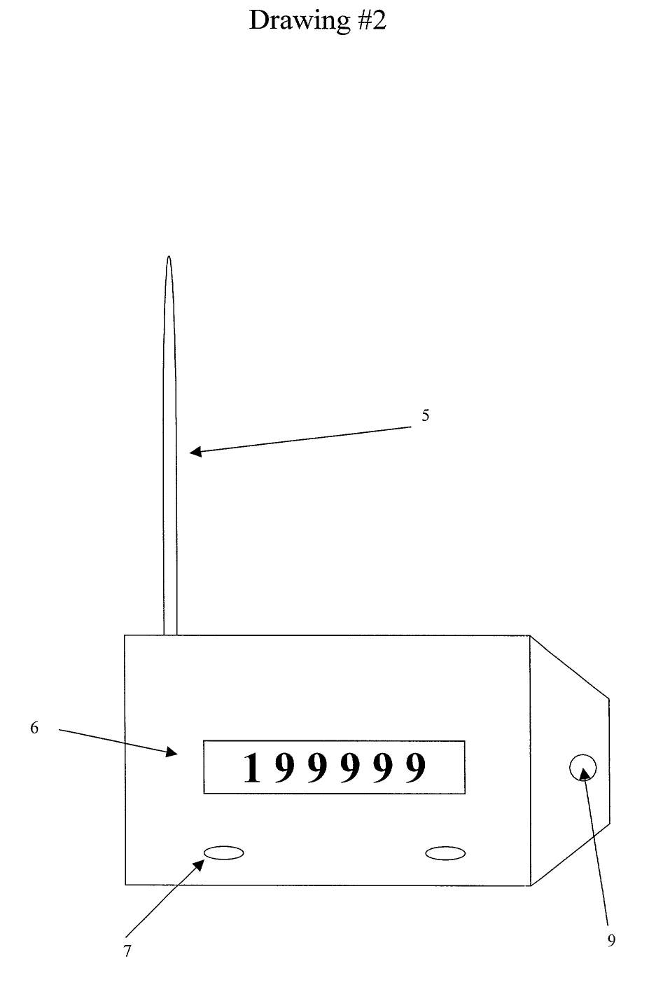

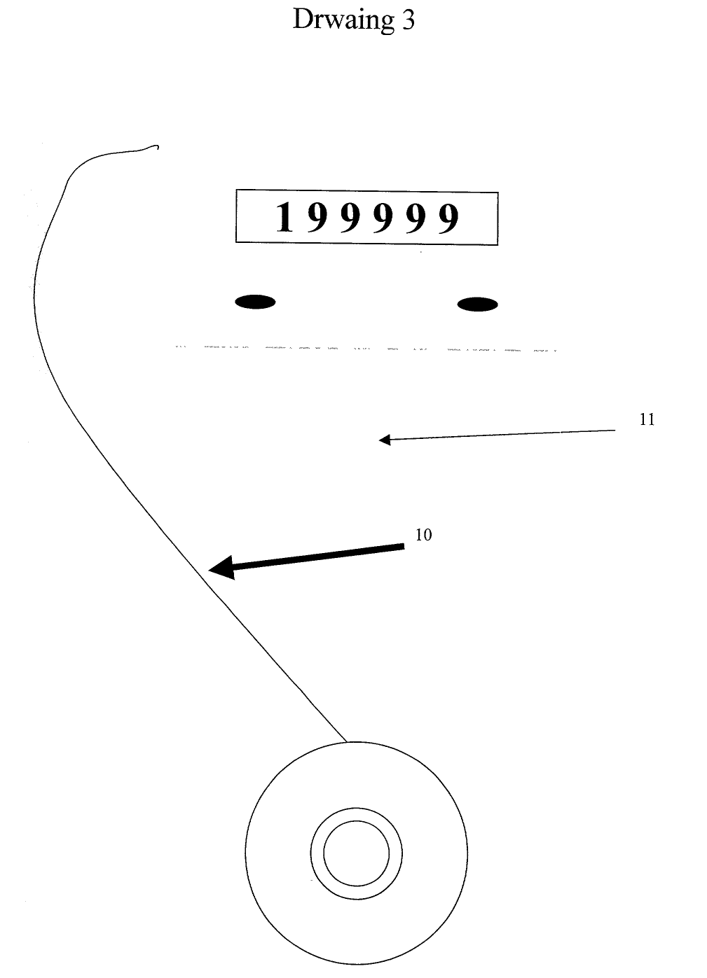

### FIELD OF THE INVENTION

The present invention is the first meter made that can be mounted on an engine or motor and be able to pick up signal with out the use of any wires to receive the data and then display it or store the date in memory for recall. All other meter require lead wire to be connected to the meter, but Paul's Wireless information meter does not require any wires at all, it is wireless.

Mr. Paul Crunk conceived the idea of having a wireless meter late 1997 that would keep track of service hours, the RPM and any other data required by the end user or manufacturer of a product. Mr. Crunk has been working on this project since then and has finally come up with fully working meter as of Aug. 31, 2001

### BACKGROUND OF THE INVENTION

A wireless information meter they could be used on gasoline, diesel, electric motors or any electrical application to record data of hours or use, RPM or any other data required, which can be used by the end user or the manufacturer of that product to be able to keep track of the running operation of any gasoline or electrical product in more detail.

This wireless service meter could just keep track of rpm and hours or just keep track of service hours depending on which model a customer required and features needed for the application of use. The applications of use are endless. Some of the applications of use are furnaces, air-conditioners, water pumps, compressors, electrical usage on equipment, hours the equipment is being used and service alarms that alert the users of the equipment that service time and 1 or more service timers, plus eight rpm feature which can operate off of inductive pickup or be able to receive a pulse signal through a standard electrical wire. These service timers on the wireless meter could also be activated by receiving energy being produced by most standard electrical devices being used on 110 volts through 240 volts D.C. or AC power. At this present time in the electrical market on many pieces of equipment including motors air-conditioners furnaces and many heating and cooling equipment there is no such recording device attached to the product. Many have said that is hard to do service on bearings or customers being able to set up some type of service interval to be able to apply lubrication or grease to bearings on many electrical equipment applications. They also have mentioned they would like to have a way of knowing how many hours and at what rpm the motor was operated at and be able to get this information from the meter and download into a laptop computer directly at the site or via telecommunications equipment by a person from a remote location tracking many pieces of equipment nationwide or international.

Paul Crunk has been working on this project for the last 5 years and now has invented Wireless information meter. The meter is able to receive a pulse signals, inductive signals or RF via the air or thought a metal structure or electrical non-engine wire application to where the meter is mounted thereto. The meter does not have to be mounted in the area of the engine or electrical to be able to operate. The meter can be able to display hours and minutes and engine RPM. The meter can use a digital or analogue display. The meter can be set up to be able to store all data for recall at a later date and then read through a portable PC, hand held reader, palm pilot or direct from the meter digital display. The meter is able to have an internal or external antenna Drawing 1 #1,#2, #3 on the exterior of the meter. The external antenna can at times make direct contact with the metal structure for better reception of the signal of that engine only and No false signals from other engines nearby.

Paul's wireless maintenance meter is the first of its kind, because all other meters require some sort of wire or cable to bring the information or signal to the meter. Also the other meters need to be within 2-6 inches of the spark plug and the wire must be attached to the meter out case in some way and the other end must be attached to a spark plug wire so it can operate and display the information to the user. Most users would like the meter placed a distance from the source and not require any sort of wires needing to be attached to a spark plug wire, spark plug, engine kill wire, engine ignition system or an electrical AC wire source for it to be able to operate the meter.

Paul's wireless meter can be placed over 3 inches to over 6 feet away form the source the engine or motor and is able to receive the signal from the engine to the point of where the meter is mounted. Some week signal engines will require a lead wire from the spark plug wire to be connected to a metal structure frame to help transfer the signal into the equipment being used.

### DESCRIPTION OF DRAWINGS

The Wireless maintenance meter can be mounted on a metal bracket Drawing 2 #10 or on a plastic bracket with an antenna built into or on the plastic bracket. Problems with wireless has been that when water makes direct contact with the external antenna or the meter, the meter hour meter will keep running. I also have found that by mounting the meter into a special designed plastic bracket and at the proper distance and antenna at a certain length and running it a certain angle and at proper distance from the metal surface adding filters etc to meter it was able to receive and record the data in the meter accurately at over 6 feet away See Drawing 3 #10 and #11

### DETAILED DESCRIPTION OF THE PREFERRED EMBODIMENT

I have done a patent search on the web and do not find any wireless tachometers or service meters that can be attached to equipment etc that does not require wires to be attached to the meter in some way.

My wireless meters does not require ANY wires to power it or make it function.

My wireless meter can be also powered by the engine kill wire, AC/DC voltage of 0.05 volts and up or can run directly from the internal lithium battery. The wireless meter can be set up with our standard auto switching circuit if customers require meters to have it for external power applications which the wish not to have an internal battery. The meter can also run directly off external power with out the use on the internal battery and be able to keep all recorded data stored in the meter for later recall. The meter can come in any size to meet any application or customer designs. The meter can display run-time, total-time; any number of service timers and can also keep track of other data required. The meter can count up or down and it can display RPM in actual run time and display highest RPM or average RPM, or lowest RPM or can turn off a circuit or motor or engine if rpm exceeds a certain level. The meter can be also set up to receive date sent from a transmitter to set up or clear any data from memory or retrieve from memory the information like water temp, head temp, oil pressure or any other data needed without having to be present or the use of any wires.

The major thing about this type of meter is it is able to operate and display without the use of any wires at all and can be placed at great distances from the engine or electrical motor.

What is claimed is:

1 A wireless information meter that does not require the use of any wires to make it operate, record data or send data and can be set or cleared using any number of control buttons on the meter or set with a hand held transmitter and reader.

2 A wireless information meter that is capable of clocking up and down hours and minutes, RPM, engine temp, oil pressure, voltage, speed, or any other function needed, which is able to track and display current and past RPM by making contact with the engine or frame or metal structure where it can receive the signal from the engine of the application it is being used on.

3 A wireless information meter that is capable of tracking engine rpm, hours and minutes and other functions needed on a gasoline, diesel or electrical motor used in unlimited applications receiving information via RF signal or magnetic wave.

4 A wireless meter Dependant on claim 2 that is capable of storing all data in the meter by EEprom or Flash Memory to be viewed by the consumer, manufacture, dealer or service department, which can be used in tracking of service and performance and analyses.

5 A wireless meter dependent on claim 1 that is capable of being read by hand held reader, which could read meter information or program or store information into the meter from the hand held transmitter/reader or can be read (displayed) with the use of control buttons on the meter it self.

6 A wireless meter dependent on claim 1 capable up being programmed by the consumer by control buttons on the meter or by a hand held or other communications equipment using digital, RF technology or the use of water to transmit and receive data.

7 A wireless meter dependant on claim 1 to be programmed at the factory that can't be changed by any person.

8 A wireless meter dependent on claim 1 or 3 capable of being programmed by hand held unit, which the user never has to make contact with the meter and can choose the engine configuration or electric motor setting to match the engine motor it is being use on or can upload or download information directly to the meter.

9 A wireless meter dependant on claim 1-3 capable on receiving information from other instrumentation sent to the meter via the air or through a metal structure picked up by the wireless meter in the place it is mounted.

10 A wireless meters that can use both Internal and external power to power the meter.

11 A wireless meter dependent on claim 1 that can have one or more external connections for outputs to send or receive data to the meter for uploading or downloading purposes.

12 A wireless meter dependant on claim 3 is capable on receiving and transmitting all information through the air with the use of digital communications, inferred, microwave communications, telephone, palm pilot, or in any other way to a location looking to receive data from one or many other wireless meters for data retrieval, downloading, uploading or processing data.

13 A wireless meter dependent on claim 1-3 being housed in a plastic case or other housing, which is waterproof and can have a non replaceable battery or a replaceable battery where the screws that hold the battery cover or case back on place can be used as an antenna for better reception of the signals.

14 A wireless meter dependant on claim 1-3 where only a dealer or manufacture is able to set various timers' functions or other information in the meter.

15 A wireless meter dependant on claim 1-3 having an internal or external antenna to any length or coil attached to the meter in any way tuned that helps the meter receives the signal much better via the air or through the wiring or framework of the equipment, machine engine, or motor, an electrical AC or DC wire or inductive singles or RF signals.

16 A wireless meter dependant on claim 3 having a straight metal or aluminum antenna coming out of the meter to a certain length, tuned to pick up a specific signal or signals being generated by electrical AC or DC wire appliances or inductive spark signals.

17 A wireless meter dependent on claim 1 and 3 having a specially designed mounting bracket metal or plastic material containing an antenna molded into or fastened onto this bracket to aid in signal reception by the meter designed to receive the signal from the framing or metal structure in which it is mounted thereto.

18 A wireless meter dependant on claim 1-3 having no display to the show data in the meter display.

19 A wireless meter having dependant on claim 3 where the antenna is part of the PCB board in the meter.

20 A wireless meter dependant on claim 1-3 where the meter can be charged up using a non-contact charger or can be charged up where the meter contacts points that meet the contacts points in the charger to charge the internal battery.
